(19) United States
(12) Patent Application Publication
(10) Pub. No.: US 2026/0054356 A1
(43) Pub. Date: Feb. 26, 2026

(54) Stabilizing and Sealing Gasket for a Ratchet Tool

(71) Applicant: Harbor Freight Tools USA, Inc., Calabasas, CA (US)

(72) Inventor: Oaty A. Frye, JR., Middletown, CT (US)

(21) Appl. No.: 18/809,581

(22) Filed: Aug. 20, 2024

(51) Int. Cl. B25B 13/46; F16J 15/3204

(52) U.S. Cl. CPC B25B 13/463; F16J 15/3204

(57) ABSTRACT

A ratchet tool that includes a stabilizing and sealing gasket is disclosed. The gasket is disposed between a cover plate and a ratchet gear. The gasket may be disposed within an annular recess of the cover plate and includes at least one contact surface to prevent debris and/or fluids from entering a ratchet assembly cavity of a ratchet head. The gasket is also operable to bias the ratchet gear towards a bottom surface of the ratchet assembly cavity and along a rotational axis of the ratchet gear, thereby providing a more reliable ratchet tool.

### BACKGROUND

The present disclosure relates generally to a gasket for use in a ratchet tool. Ratchet tools include for example ratchet wrenches and torque wrenches. Such ratchet tools typically include a reversible drive, which is capable of applying torque to a work piece in both a first rotational direction or a second rotational direction to tighten or loosen fasteners.

Ratchet tools generally include a cavity in a ratchet head that receives a cylindrical gear attached to the drive member, a pawl to engage the gear, a switch to control the relative orientation of the pawl with respect to the gear, and a biasing member disposed within the switch. A cover plate may be attached to the ratchet head to retain the internal components within the cavity of the ratchet tool.

Traditional ratchet tools often include a drive member that protrudes through an aperture in the cover plate. Given the space between the drive member and the aperture of the cover plate, debris and/or fluids may enter the cavity of the ratchet head. Exposure to such debris and/or fluids may lead to abrasion on the surfaces of the internal components of the ratchet tool, or, may compromise the mechanical engagement of the internal components. Indeed, the application of torque to a fastener relies on the mechanical engagement of the pawl and the ratchet gear preventing rotation of the ratchet gear (and in turn the drive member) in either the first or the second rotational direction. It is therefore advantageous to seal the cavity of a ratchet gear to prevent debris and/or fluids from entering the cavity of the ratchet head and to retain any lubricant or medium within the cavity.

Traditional ratchet tools also exhibit instability between the internal components due to differences in manufacturing tolerances and variable configurations. For example, some ratchet tools seek to stabilize the internal components of the ratchet head with a spacer. Such spacers, however, are incapable of excluding debris, fluids, and/or contaminants from the cavity of the ratchet head. While some ratchet tools include o-rings or gaskets to prevent debris and/or fluids from entering the cavity of the ratchet head, these o-rings and gaskets do not additionally provide contact forces on the ratchet gear to prevent axial and/or radial displacement of the ratchet gear. Such axial and radial displacement of the ratchet gear effects the ratchet gear to pawl engagement, which could result in the ratchet gear wearing down. It is therefore advantageous to improve the reliability of a ratchet tool by stabilizing the ratchet gear and sealing the cavity of the ratchet head with a gasket.

### SUMMARY

Specifically disclosed is an example ratchet tool. The ratchet tool includes a cover plate attachable to a ratchet head, a ratchet assembly cavity disposed in the ratchet head, and a ratchet assembly disposed in the ratchet assembly cavity. The ratchet assembly includes a ratchet gear rotatably disposed in the ratchet assembly cavity. The ratchet gear includes a drive member centrally located on a top surface of the ratchet gear, the drive member operable to transmit torque to a work piece. The ratchet assembly further includes a gasket disposed between the ratchet gear and the cover plate. The gasket contacts the drive member and the top surface of the ratchet gear.

In one example, the gasket includes a lip defining a through opening operable to receive at least a portion of the drive member, a first shoulder, and a second shoulder. In this example, the lip contacts at least a portion of the drive member, the first shoulder contacts at least a portion of the cover plate, and the second shoulder contacts at least a portion of the top surface of the ratchet gear.

In another example, a diameter of the through opening of the gasket is less than or equal to a diameter of the drive member, and the gasket forms a seal between the lip of the gasket and the drive member. In one example, the first shoulder and the second shoulder are compressed between the ratchet gear and the cover plate. In this example, the gasket forms a first seal between the first shoulder and the cover plate and the gasket forms a second seal between the second shoulder and the top surface of the ratchet gear.

In another example, the gasket is comprised of rubber. In one example, the lip of the gasket is operable to maintain a positioning of the drive member along a drive axis. In another example, the first shoulder and the second shoulder of the gasket are operable to bias the ratchet gear towards a bottom surface of the ratchet assembly cavity. In yet another example, the cover plate further comprises an annular recess operable to receive the gasket.

Also disclosed is another example ratchet tool. The ratchet tool includes a cover plate attachable to a ratchet head. The cover plate includes an annular recess. The ratchet tool further includes a ratchet assembly cavity disposed in the ratchet head and a ratchet assembly disposed in the ratchet assembly cavity. The ratchet assembly includes a ratchet gear rotatably disposed in the ratchet assembly cavity. The ratchet gear includes a drive member centrally located on a top surface of the ratchet gear, the drive member operable to transmit torque to a work piece. The ratchet assembly further includes a gasket disposed within the annular recess of the cover plate. The gasket contacts at least a portion of the drive member and at least a portion of the top surface of the ratchet gear.

In one example, the annular recess includes a sidewall and a seat. In this example, the sidewall contacts at least a portion of the first shoulder and the second shoulder to maintain a positioning of the gasket relative to drive member, and the seat contacts at least a portion of the first shoulder to maintain a positioning of the gasket relative to the ratchet gear.

In another example, the gasket includes a lip defining a through opening operable to receive at least a portion of the drive member, a first shoulder, and a second shoulder. In this example, the lip contacts at least a portion of the drive member, the first shoulder contacts at least a portion of the cover plate, and the second shoulder contacts at least a portion of the top surface of the ratchet gear. In one example, a diameter of the through opening of the gasket is less than or equal to a diameter of the drive member, and the gasket forms a seal between the lip of the gasket and the drive member.

In one example, the first shoulder and the second shoulder are compressed between the ratchet gear and the cover plate. In this example, the gasket forms a first seal between the first shoulder and the seat of the recess, and the gasket forms a second seal between the second shoulder and the top surface of the ratchet gear. In another example, the gasket is comprised of rubber. In yet another example, the lip of the gasket is operable to maintain a positioning of the drive member along a drive axis.

In one example, the first shoulder and the second shoulder of the gasket are operable to bias the ratchet gear towards a bottom surface of the ratchet assembly cavity.

Also disclosed is an example gasket for a ratchet tool. The gasket includes a lip defining a through opening operable to receive at least a portion of a drive member of a ratchet gear. The lip contacts at least a portion of the drive member. The gasket further includes a first shoulder and a second shoulder disposed between the ratchet gear and a cover plate attachable to a ratchet head. The first shoulder contacts the cover plate and the second shoulder contacts the ratchet gear.

In one example, the gasket is comprised of rubber. In another example, the gasket is disposed within an annular recess of the cover plate, the annular recess including a seat and a sidewall operable to receive portions of the gasket. In one example, the lip of the gasket is operable to maintain a positioning of the ratchet gear along a drive axis. In yet another example, the first shoulder and the second shoulder comprises a thickness greater than the distance between the seat of the recess and a bottom surface of a cover plate.

### BRIEF DESCRIPTION OF SEVERAL VIEWS OF DRAWINGS

The following is a brief description of the drawings pertaining to the present disclosure, which will be discussed in more detail in the detailed description section below:

FIG. 1 illustrates an exploded perspective view of a ratchet head of a ratchet tool.

FIG. 2 illustrates an exploded, bottom perspective view of the ratchet head, showing a recess within a cover plate operable to receive a gasket.

FIG. 3 illustrates a top perspective, assembled view of the ratchet head showing a gasket disposed within the recess and around a drive member of a ratchet gear within a ratchet assembly cavity.

FIG. 4 illustrates a cross sectional view of the gasket disposed within the ratchet head taken along the lines of 4-4 in FIG. 3, and showing reference to FIG. 5.

FIG. 5 illustrates a close-up cross sectional view of the gasket disposed within the recess of the cover plate proximate the ratchet gear.

The foregoing summary, as well as the following detailed description of certain features of the present application, are better understood when read in conjunction with the appended drawings. For the purposes of illustration, certain features are shown in the drawings. It should be understood, however, that the claims are not limited to the arrangements shown in the attached drawings. Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of applications comprising one or more embodiments of the disclosure. As such, the drawings are not meant to include all conventional features known by those of ordinary skill in the art to be required for the practice of the embodiments disclosed herein.

### DETAILED DESCRIPTION

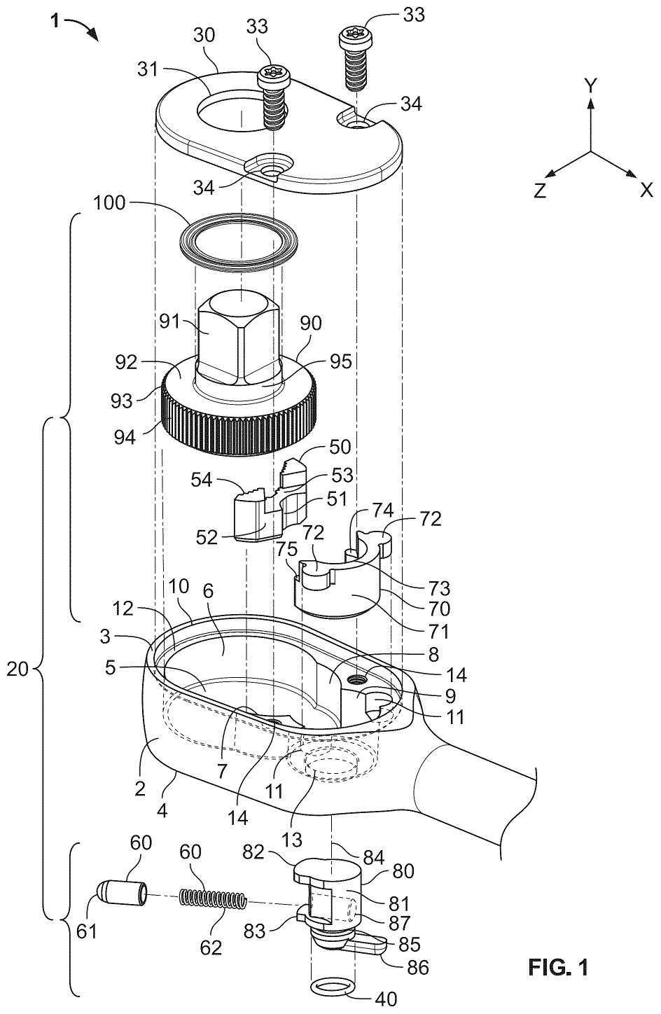

The present disclosure relates to a ratchet tool that enables a user to selectively determine the direction (i.e., clockwise or counter-clockwise) in which torque is applied to a work piece (not shown). Amongst other factors, a reliable ratchet tool requires stabile yet dynamic engagement of the tool's internal and/or external components, free of any debris, fluids, and/or contaminants. A ratchet tool 1 is shown in the exploded view of FIG. 1. Also shown in FIG. 1 are x, y, and z axes to assist in the description of the various movements and relationships of the internal components of the ratchet tool 1. As illustrated, the ratchet tool 1 of the present disclosure comprises a ratchet assembly 20 that includes a gasket 100, a ratchet gear 90, a switch 80, a sleeve 70, a biasing member 60, and a pawl 50. The ratchet assembly 20 is disposed in a ratchet assembly cavity 10 of a ratchet head 2. The ratchet assembly cavity 10 includes a bottom surface 5, a gear sidewall 6, a first sidewall 7, a second sidewall 8, and a switch-sleeve cavity 9 operable to receive the switch 80 and the sleeve 70. The gear sidewall 6 extends from the first sidewall 7 and second sidewall 8 forming an arcuate shape that is substantially complementary to the shape of the ratchet gear 90. As shown in FIG. 1, gear sidewall 6 is positioned adjacent first sidewall 7 and second sidewall 8 and is operable to receive at least a portion of the ratchet gear 90. First sidewall 7 and second sidewall 8 each define a curved surface that is substantially complementary to the shape of the pawl 50 and are operable to receive at least a portion of the pawl 50. At least a portion of pawl 50 is positioned between the first sidewall 7 and second sidewall 8 and at least a portion of the ratchet gear 90 is positioned within gear sidewall 6. When assembled, ratchet gear 90 and pawl 50 contact the bottom surface 5 of the ratchet assembly cavity 10. A cover plate 30 attachable to the ratchet head 2 is operable to retain the ratchet assembly 20 within the ratchet assembly cavity 10.

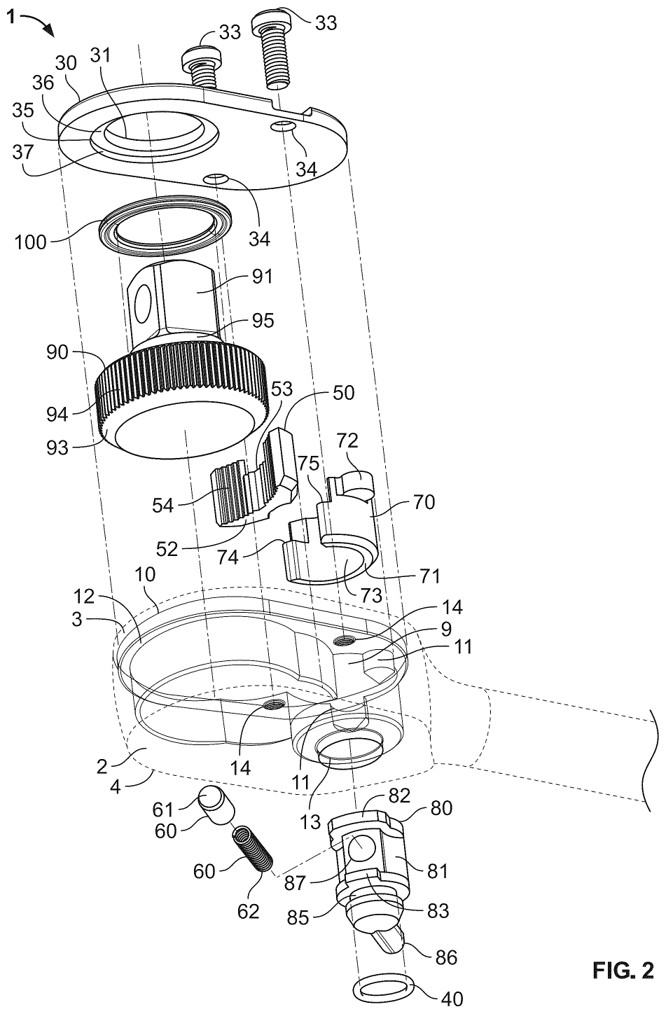

FIGS. 1 and 2 show the sleeve 70 that includes a sleeve body 71 that has at least a partially circumferential shape and at least partially surrounds the switch 80. The sleeve 70 further includes at least one anchor 72 operable to engage with at least one anchor pocket 11 disposed in the switch-sleeve cavity 9 such that the sleeve 70 stabilizes the switch 80 within the ratchet head 2, and specifically, within the switch-sleeve cavity 9. The sleeve 70 further includes a first portion 74 and a second portion 75 disposed on opposite ends of the body 71 operable to limit rotation of the switch 80 in a clockwise or counter-clockwise direction along the y-axis. The present disclosure also contemplates the ratchet tool 1 that does not include the sleeve 70.

FIGS. 1 and 2 show the switch 80 rotatably disposed through a switch aperture 13 in the ratchet assembly cavity 10 and positioned adjacent to a switch pocket 73 of the sleeve 70. The switch 80 includes a switch body 81 and a first ledge 82 that extends away, or laterally, from a central z-axis 84 of the switch body 81. The switch 80 further includes a second ledge 83 that extends away, or laterally, from the central z-axis 84 of the switch body 81. A portion of the pawl 50 is received between the first ledge 82 and the second ledge 83, thereby limiting movement of the pawl 50 along the y-axis when the switch 80 is rotated clockwise or counter-clockwise. As shown, the first ledge 82 is positioned on one side of the biasing member 60 and the second ledge 83 is positioned on the opposite side of the biasing member 60 from which where the first ledge 82 is positioned. In the illustrated embodiment, the ratchet assembly 20 includes an o-ring 40 disposed around a neck 85 of the switch 80 to seal the switch aperture 13, thereby preventing debris and/or fluids from entering the switch-sleeve cavity 9 through the switch aperture 13.

The user may activate the switch 80 via a switch lever 86 that extends out of the switch aperture 13 and is positioned on a rear side 4 of the ratchet head 2, opposite a front side 3 of the ratchet head 2. The user may rotate the switch 80, via the lever 86 either clockwise or counter-clockwise along the y-axis to move the pawl 50 to engage with the ratchet gear 90. In the illustrated embodiment, the switch 80 defines a bore 87 configured to partially receive the biasing member 60 that includes a pin 61 and a spring 62. The biasing member 60 uses elastic potential energy, i.e., a biasing force generated by the compression of the spring 62, to push the pin 61 into engagement with a rear surface 51 of the pawl 50, thereby pushing the pawl 50 against the ratchet gear 90.

FIGS. 1-3 show the ratchet gear 90 rotatably disposed in the ratchet assembly cavity 10. The ratchet gear 90 includes a drive member 91 centrally located on a top surface 92 of the ratchet gear 90 for transmitting torque to a work piece (not shown). The ratchet gear 90 defines a perimeter 93 and a plurality of gear teeth 94 disposed about the perimeter 93 to selectively engage with the pawl 50. The ratchet gear 90 also includes a collar 95 positioned between the top surface 92 of the ratchet gear 90 and the drive member 91. The collar 95 may substantially correspond to the shape of a drive aperture 31 of the cover plate 30 to prevent debris from entering the ratchet assembly cavity 10 through the drive aperture 31. The drive member 91 is operable to engage with a socket, fastener, or other tool. As shown, the drive member 91 has a substantially square shape, but may also have a rectangular or other shape. The drive member 91 may optionally include a ball detent operable to engage with a conventional socket.

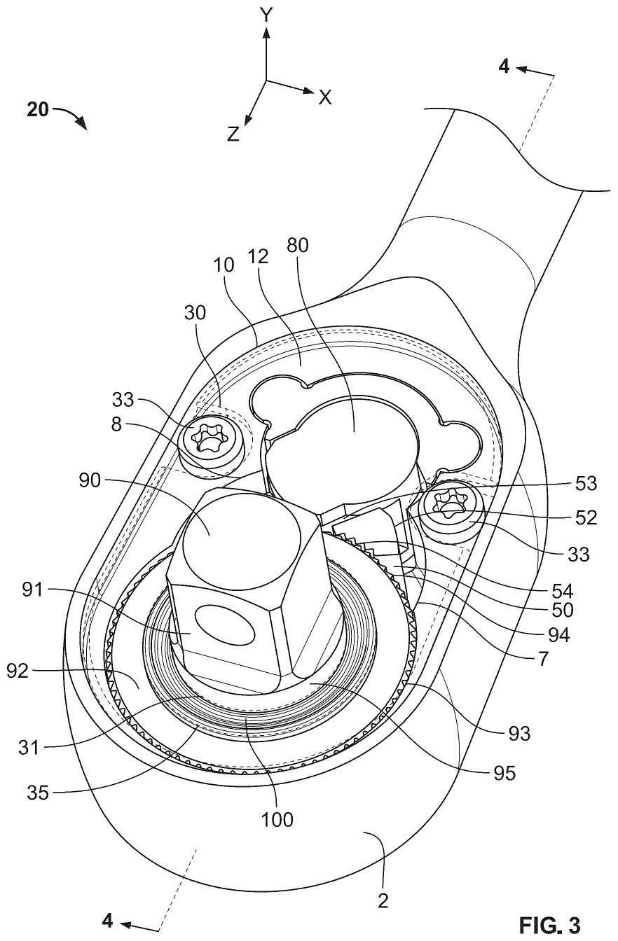

FIGS. 1-3 show the pawl 50 that includes a body 52 that has a rounded shape that conforms to a portion of the perimeter of the ratchet gear 90. A plurality of pawl teeth 54 are disposed on the side of the pawl 50 that faces the ratchet gear 90. The pawl 50 also includes a recessed portion 53 disposed within the pawl body 52. The recessed portion 53 is operable to receive the biasing member 60 to selectively engage the pawl 50 into either the clockwise or counter-clockwise position. As shown in FIG. 3, the pawl teeth 54 are operable to selectively engage the circumferential ratchet gear teeth 94 to limit rotation of the ratchet gear 90 in either a clockwise or a counterclockwise direction (about the y-axis). Specifically, in operation, the pawl 50 is wedged between the first sidewall 7 and the second sidewall8 of the ratchet assembly cavity 10 and the ratchet gear 90 (on either the left (counter-clockwise) or right side (clockwise) of the ratchet gear 90 depending on selected drive direction) when the switch 80 is positioned in either the clockwise or counter-clockwise position. The position of the pawl 50 relative to the ratchet gear 90, and specifically the engagement of the pawl teeth 54 with the gear teeth 94, limits rotation of the ratchet gear 90 in either the clockwise or counter-clockwise direction, such that torque can be applied to a work piece (not shown) in a clockwise or counter-clockwise direction.

FIGS. 1-3 show the cover plate 30 at least partially disposed in a cover plate cavity 12. The cover plate 30 is secured to the ratchet head 2 and is operable to retain the ratchet assembly 20 within the ratchet assembly cavity 10. As illustrated, the cover plate 30 includes the drive aperture 31 operable to receive at least a portion of the drive member 91 and a plurality of bores 34 operable to receive a plurality of screws 33. Similarly, the cover plate cavity 12 on the ratchet head 2 includes a plurality of threaded holes 14 co-axial with the plurality of bores 34 of the cover plate 30. To fasten the cover plate 30 to the ratchet head 2, the screws 33 are inserted through the plurality of bores 34 in the cover plate 30 and engaged with the plurality of holes 14 in the cover plate cavity 12. Fastening the cover plate 30 to the ratchet head 2 compresses the cover plate 30 against the cover plate cavity 12 and against the internal components of the ratchet head 2 (i.e., the ratchet assembly 20) along the y-axis. As best seen in FIG. 2, the cover plate 30 includes an annular recess 35 disposed proximate the drive aperture 31. The annular recess 35 is operable to receive the gasket 100. Further, the annular recess includes a seat 36 and a sidewall 37, each of which are operable to receive portions of the gasket 100. The present disclosure contemplates a variety of geometries for the annular recess 35 such that the shape of the annular recess 35 corresponds to the gasket 100.

FIGS. 1-3 show the gasket 100 disposed between the ratchet gear 90 and the cover plate 30. FIG. 3 shows the gasket 100 disposed within the ratchet assembly cavity 10 and around the collar 95 of the drive member 91. The gasket 100 is comprised of any suitable material including but not limited to polyacrylate, silicone, nitrile rubber, fluoropolymers (fluoroelastomers), and polytetrafluoroethylene (PTFE). In some embodiments, the gasket 100 includes a reinforcement ring (not shown), optionally comprised of metal or plastic, and disposed internal or external to the gasket 100 to increase the rigidity and strength of the gasket 100.

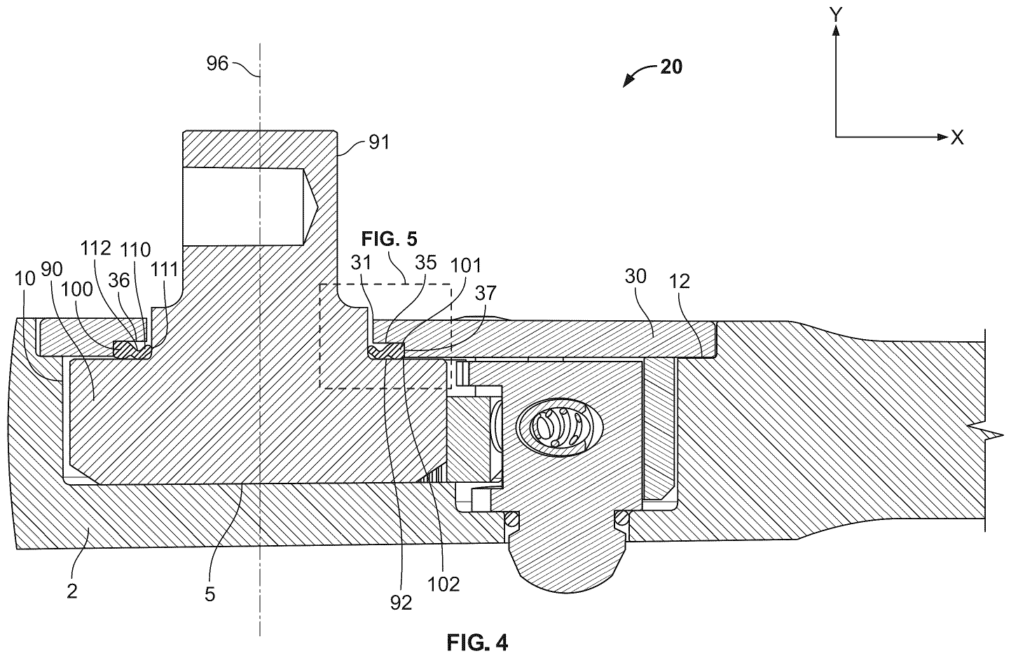

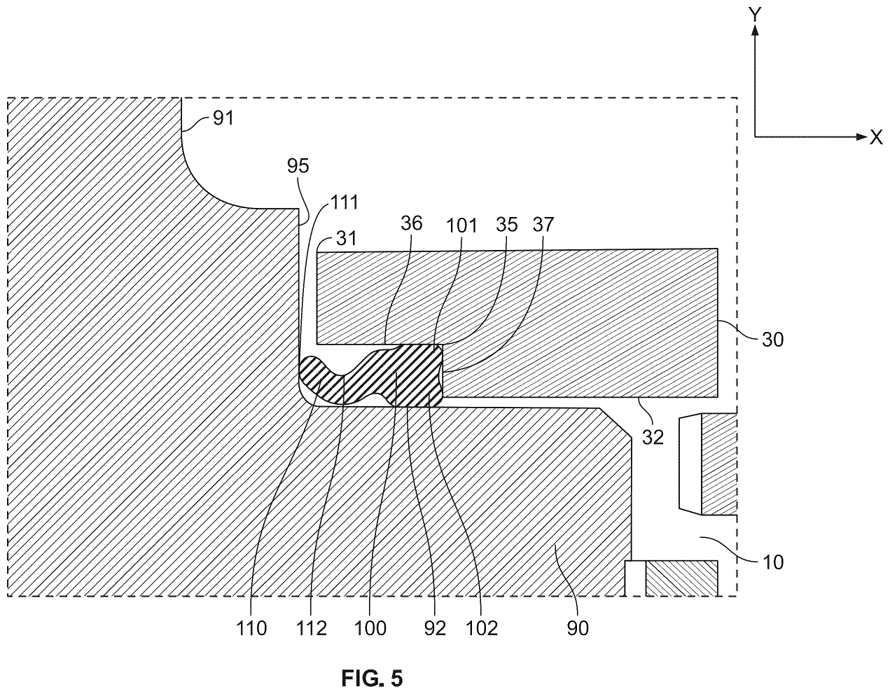

FIGS. 4 and 5 show a first shoulder 101 and second shoulder 102 of the gasket 100 that define an outer diameter of the gasket 100. The gasket 100 further includes a first thickness comprised of a cross section of the first shoulder 101 and the second shoulder 102. As shown in FIG. 5, the first thickness is greater than the distance between the seat 36 of the annular recess 35 and a bottom surface 32 of the cover plate 30. The present disclosure contemplates modifying the first thickness of the gasket 100 within a range of appropriate thicknesses relative to the components of the ratchet head 2.

FIGS. 4 and 5 show a lip 110 of the gasket 100 defining a through opening 111 and an inner diameter of the gasket 100. The through opening 111 is operable to receive at least a portion of the drive member 91. In the illustrated embodiment, the lip 110 includes at least one concave portion 112 relative to the seat 36 of the annular recess 35. In other embodiments, the lip 110 includes at least one convex portion relative to the seat 36 of the annular recess 35. The gasket 100 further includes a second thickness comprised of a cross section of the lip 110. In the illustrated embodiment, the first thickness of the first and second shoulders 101,102 is thicker than the second thickness of the lip 110. As such, in some embodiments, the lip 110 includes a thinner cross section while in other embodiments, the lip 110 includes a thicker cross section. The present disclosure contemplates modifying the second thickness of the gasket 100 within a range of appropriate thicknesses relative to the components of the ratchet head 2.

FIGS. 4 and 5 show the gasket 100 in contact with the surfaces of the drive member 91 and the annular recess 35 such that the ratchet assembly cavity 10 is sealed. As discussed above, debris and/or fluids may enter the space between the drive aperture 31 and the drive member 91 making it advantageous to seal off the ratchet assembly cavity 10. In some embodiments, the gasket 100 includes at least one contact surface to prevent debris and/or fluids from entering the ratchet assembly cavity 10 through the space between the drive member 91 and the drive aperture 31 of the cover plate 30. In the illustrated embodiment, the gasket 100 includes at least two contact surfaces. In other embodiments, the gasket includes at least five contact surfaces. A contact surface, as used herein, includes but is not limited to any portion of the gasket 100 that contacts any portion of the ratchet gear 90, cover plate 30, ratchet assembly 20, and/or ratchet assembly cavity 10.

For example, FIG. 5 shows the lip 110 of the gasket 100 in contact with the drive member 91. Because of the interference fit between the inner diameter of the gasket 100, i.e., the diameter of the through opening 111, relative to the diameter of the drive member 91, the lip 110 contacts the collar 95 of the drive member 91 to seal the space between the collar 95 and the lip 110. Sealing this space prevents debris and/or fluids from entering the ratchet assembly cavity 10 through the space between the drive aperture 31 and the drive member 91.

Additionally, FIG. 5 shows the first shoulder 101 in contact with the seat 36 of the annular recess 35. Also shown the second shoulder 102 is in contact with the top surface 92 of the ratchet gear 90. Attaching the cover plate 30 to the ratchet head 2 brings the bottom surface 32 of the cover plate 30 in contact with (or, co-planar with) the cover plate cavity 12 (See e.g., FIG. 4). Doing so also provides axial compression along the y-axis to the gasket 100. The first shoulder 101 and second shoulder 102 are therefore compressed between the seat 36 of the recess 35 and the top surface 92 of the ratchet gear 90, forcing the first shoulder 101 to contact the seat 36, and the second shoulder 102 to contact the top surface 92 of the ratchet gear 90. As such, the space between the first shoulder 101 and the seat 36 is sealed and the space between the second shoulder 102 and the top surface 92 of the ratchet gear 90 is also sealed. Sealing these spaces prevents debris and/or fluids from entering the ratchet assembly cavity 10 through the space between the drive aperture 31 and the drive member 91.

With reference to FIGS. 4 and 5, the gasket 100 within the ratchet head 2 tolerates a range of axial displacement of the ratchet gear 90 along the y-axis. As discussed above, securing the cover plate 30 to the ratchet head 2 provides axial compression to the gasket 100, specifically, axial compression of the first shoulder 101 and the second shoulder 102 between the seat 36 of the annular recess 35 and the top surface 92 of the ratchet gear 90. Because of the axial compression, the elasticity of the gasket 100, and the thickness of the gasket 100 relative to the distance between the seat 36 and the bottom surface 32 of the cover plate 30, the gasket 100 exerts an axial force (resultant force) along the y-axis on the top surface 92 of the ratchet gear 90. In other words, the second shoulder 102 is forced into axial contact with the top surface 92 of the ratchet gear 90 to bias the ratchet gear 90 towards the bottom surface 5 of the ratchet assembly cavity 10. Biasing the ratchet gear 90 towards the bottom surface 5 keeps the ratchet gear 90 seated and flat on the bottom surface 5 of the ratchet assembly cavity 10 during use.

Additionally, the gasket 100 within the ratchet head 2 tolerates a range of radial deviation relative to a true center (or rotational axis) 96 of the ratchet gear 90 along the x-axis. Due to the elasticity of the gasket 100 and the interference fit between the diameter of the through opening 111 of the lip 110 relative to the diameter of the drive member 91, the lip 110 of the gasket 100 exerts a radial force (resultant force) on the drive member 91 along the x-axis. In some embodiments, a spring (not shown) is disposed around the lip 110, and optionally, within a cavity on the lip 110, to alter the radial tension of the lip 110 disposed around the drive member 91. Furthermore, inserting the gasket 100 within the annular recess 35 places the gasket 100 in radial compression between the drive member 91 and the sidewall 37 of the recess 35. As shown in FIG. 5, lip 110 contacts the drive member 91 and the first and second shoulders 101,102 each contact the sidewall 37 of the annular recess 35. Because of the shape and relative deflection of the lip 110, the lip 110 exerts a radial force (resultant force) on the drive member 91 of the ratchet gear 90 along the x-axis. As such, the lip 110 is forced into radial contact with the drive member 91 to bias the drive member 91 along a rotational axis, i.e., true center 96. Biasing the drive member 91 towards the true center 96 of the drive member 91 along the rotational axis improves the stability of the ratchet gear 90 during use. The present disclosure contemplates that the lip 110 has a range of deflection upon radial deviation of the drive member 91 and radial compression of the gasket 100 within the annular recess 35.

The present disclosure contemplates a variety of lip 110 and first and second shoulders 101, 102 configurations operable to tolerate a range of axial and radial displacement of the drive member 91, and to optimize lubricant retention and contaminant exclusion. For example, in some embodiments, the gasket 100 includes a first lip and a second lip, each of which are operable to contact the drive member 91. In the illustrated embodiment, the first and second shoulders 101, 102 are partially rounded, yet in some embodiments, the first and second shoulders 101, 102 are partially squared to further conform to the seat 36 and sidewall 37 of the annular recess 35. In other embodiments, the gasket 100 includes a third shoulder disposed between the first shoulder 101 and the second shoulder 102. Indeed, the disclosed ratchet tool 1 includes at least one seal on the front side 3 of the ratchet head 2 (via gasket 100) and at least one seal on the rear side 4 of the ratchet head 2 (via o-ring 40). The ratchet tool 1 therefore prevents debris and/or fluids from entering the ratchet assembly cavity 10 and the switch-sleeve cavity 9 through the space between the drive aperture 31 and the drive member 91, and the space between the switch aperture 13 and the switch 80, respectively.

The present disclosure also contemplates an appropriate radial force exerted by the lip 110 of the gasket 100 depending on the medium being sealed within the ratchet assembly cavity 10, the rotational and axial force of the drive member 91, the operating temperature, and the pressure change across the sealing interface. As such, the gasket 100 of the present disclosure maintains the sealing interface between the lip 110 and the drive member 91, reduces friction between the lip 110 and the drive member 91, and stabilizes the ratchet gear 90 along a longitudinal and rotational axis.

The present disclosure is described in such full, clear, concise, and exact terms as to enable any person skilled in the art to which it pertains to practice the same. It is to be understood that the foregoing described preferred aspects of the disclosure and that modification may be made therein without departing from the spirit of scope of the disclosure as set forth in the appended claims. The scope of the following claims is to be accorded the broadest interpretation to encompass all such modifications and equivalent structures and functions. Therefore, it is intended that the application not be limited to the particular aspects disclosed, but that the application will include all aspects falling within the scope of the appended claims.

What is claimed is:

1. A ratchet tool comprising:
a cover plate attachable to a ratchet head;
a ratchet assembly cavity disposed in the ratchet head; and
a ratchet assembly disposed in the ratchet assembly cavity, the ratchet assembly comprising:
a ratchet gear rotatably disposed in the ratchet assembly cavity, wherein the ratchet gear includes a drive member centrally located on a top surface of the ratchet gear, the drive member operable to transmit torque to a work piece, and
a gasket disposed between the ratchet gear and the cover plate, wherein the gasket contacts the drive member and the top surface of the ratchet gear.

2. The ratchet tool of claim 1, wherein the gasket further comprises:
a lip defining a through opening operable to receive at least a portion of the drive member;
a first shoulder; and
a second shoulder,
wherein the lip contacts at least a portion of the drive member, the first shoulder contacts at least a portion of the cover plate, and the second shoulder contacts at least a portion of the top surface of the ratchet gear.

3. The ratchet tool of claim 2, wherein:
a diameter of the through opening of the gasket is less than or equal to a diameter of the drive member, and
the gasket forms a seal between the lip of the gasket and the drive member.

4. The ratchet tool of claim 3, wherein:
the first shoulder and the second shoulder are compressed between the ratchet gear and the cover plate,
the gasket forms a first seal between the first shoulder and the cover plate, and
the gasket forms a second seal between the second shoulder and the top surface of the ratchet gear.

5. The ratchet tool of claim 1, wherein the gasket is comprised of rubber.

6. The ratchet tool of claim 4, wherein the lip of the gasket is operable to maintain a positioning of the drive member along a drive axis.

7. The ratchet tool of claim 6, wherein the first shoulder and the second shoulder of the gasket are operable to bias the ratchet gear towards a bottom surface of the ratchet assembly cavity.

8. The ratchet tool of claim 1, wherein the cover plate further comprises an annular recess operable to receive the gasket.

9. A ratchet tool comprising:
a cover plate attachable to a ratchet head, the cover plate including an annular recess;
a ratchet assembly cavity disposed in the ratchet head; and
a ratchet assembly disposed in the ratchet assembly cavity, the ratchet assembly comprising:
a ratchet gear rotatably disposed in the ratchet assembly cavity, wherein the ratchet gear includes a drive member centrally located on a top surface of the ratchet gear, the drive member operable to transmit torque to a work piece, and
a gasket disposed within the annular recess of the cover plate, wherein the gasket contacts at least a portion of the drive member and at least a portion of the top surface of the ratchet gear.

10. The ratchet tool of claim 9, the annular recess further comprising a sidewall and a seat, wherein
the sidewall contacts at least a portion of the first shoulder and the second shoulder to maintain a positioning of the gasket relative to drive member, and
the seat contacts at least a portion of the first shoulder to maintain a positioning of the gasket relative to the ratchet gear.

11. The ratchet tool of claim 10, wherein the gasket further comprises:
a lip defining a through opening operable to receive at least a portion of the drive member;
a first shoulder; and
a second shoulder,
wherein, the lip contacts at least a portion of the drive member, the first shoulder contacts at least a portion of the cover plate, and the second shoulder contacts at least a portion of the top surface of the ratchet gear.

12. The ratchet tool of claim 11, wherein:
a diameter of the through opening of the gasket is less than or equal to a diameter of the drive member, and
the gasket forms a seal between the lip of the gasket and the drive member.

13. The ratchet tool of claim 12, wherein:
the first shoulder and the second shoulder are compressed between the ratchet gear and the cover plate,
the gasket forms a first seal between the first shoulder and the seat of the recess, and
the gasket forms a second seal between the second shoulder and the top surface of the ratchet gear.

14. The ratchet tool of claim 13, wherein the gasket is comprised of rubber.

15. The ratchet tool of claim 14, wherein the lip of the gasket is operable to maintain a positioning of the drive member along a drive axis.

16. The ratchet tool of claim 15, wherein the first shoulder and the second shoulder of the gasket are operable to bias the ratchet gear towards a bottom surface of the ratchet assembly cavity.

17. A gasket for a ratchet tool comprising:
a lip defining a through opening operable to receive at least a portion of a drive member of a ratchet gear, wherein the lip contacts at least a portion of the drive member; and
a first shoulder and a second shoulder disposed between the ratchet gear and a cover plate attachable to a ratchet head, wherein the first shoulder contacts the cover plate and the second shoulder contacts the ratchet gear.

18. The gasket of claim 17, wherein the gasket is comprised of rubber.

19. The gasket of claim 17, wherein the gasket is disposed within an annular recess of the cover plate, the annular recess including a seat and a sidewall operable to receive portions of the gasket.

20. The gasket of claim 17, wherein the lip of the gasket is operable to maintain a positioning of the ratchet gear along a drive axis.

21. The gasket of claim 17, wherein the first shoulder and the second shoulder comprises a thickness greater than the distance between the seat of the recess and a bottom surface of a cover plate.
